(19) United States
(12) Patent Application Publication
(10) Pub. No.: US 2014/0125057 A1
(43) Pub. Date: May 8, 2014

(54) FLANGE FOR CONNECTING A HYDRAULIC OR PNEUMATIC PIPE OF AN INDUSTRIAL MACHINE

(71) Applicant: Jean-Claude Bouricet, Veigne (FR)

(72) Inventor: Jean-Claude Bouricet, Veigne (FR)

(73) Assignee: ENSIVAL-MORET FRANCE, Saint-Quentin (FR)

(21) Appl. No.: 14/122,484

(22) PCT Filed: May 29, 2012
(86) PCT No.: PCT/EP2012/059982

§ 371 Date: Jan. 9, 2014

(30) Foreign Application Priority Data
May 30, 2011 (FR) 1154695

(51) Int. Cl. F16L 23/028

(52) U.S. Cl. CPC F16L 23/028
USPC 285/406

(57) ABSTRACT

A connection flange for connecting an industrial machine is intended to bear against a collar provided on the body of the machine and to collaborate in clamping with a corresponding connection flange. The connection flange includes an annular one-piece flange body and a split locking piece which fits around a cylindrical part of the body of the machine. The locking piece includes a first face intended to bear against a bearing surface provided on the collar and a second face constituting a thrust surface against which the flange body presses at the time of clamping.

The invention relates, in general, to the connection of pipework of machines in industrial plants, notably in the field of the chemical, petrochemical, mining or other industries.

It relates more particularly to the connection of pipework of industrial machines of the pump, valve, turbine type in a circuit in which they are intended to operate.

The connection flange may, in various applications, be used for connecting hydraulic pipework, through which a liquid circulates, or pneumatic pipework, through which a gas circulates.

Machines of this type are conventionally provided with a body which, at their inlet and/or their outlet via which they need to be connected, is provided with a pipe fitted with an end collar for connecting it to the remainder of the plant.

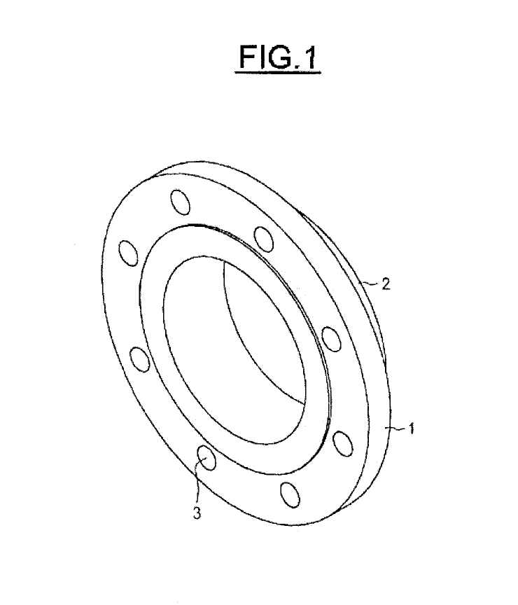

FIG. 1 depicts a first embodiment in which the collar 1 is formed as an integral part of the machine connection pipe 2 to form a flange that is provided with a certain number of axial holes, such as 3, here with eight holes, for clamping the collar 1 against a corresponding collar, with the interposition of a seal.

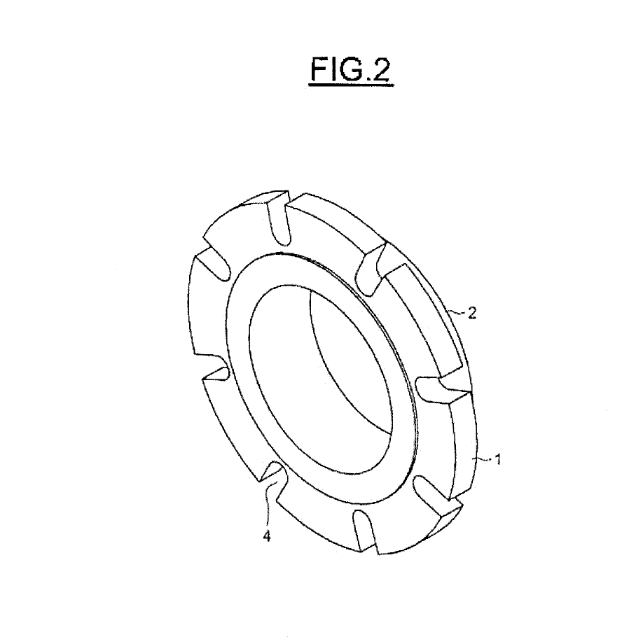

FIG. 2 depicts another embodiment of the flange in which the axial holes 3 are replaced by radial notches 4 that allow bolts to be inserted from the side.

In certain applications, particularly as far as the pumping of ores is concerned, the material that is to be handled is particularly abrasive which means that the body of the pump needs to be made of a material tough enough to withstand abrasion.

In such instances this is often made of chromium cast iron or of Ni-hard cast iron.

Such materials are particularly tough to machine and even reach the limit of machinability, which means that making holes and notches is a particularly tricky operation. This type of material, although extremely resistant to compressive loadings, is also relatively brittle, which means that the flange made of it is incapable of withstanding excessive clamping loads.

In order to alleviate this disadvantage, it has been proposed that the flange be produced in the form of a separate element separate from the pipe on which it is then fitted.

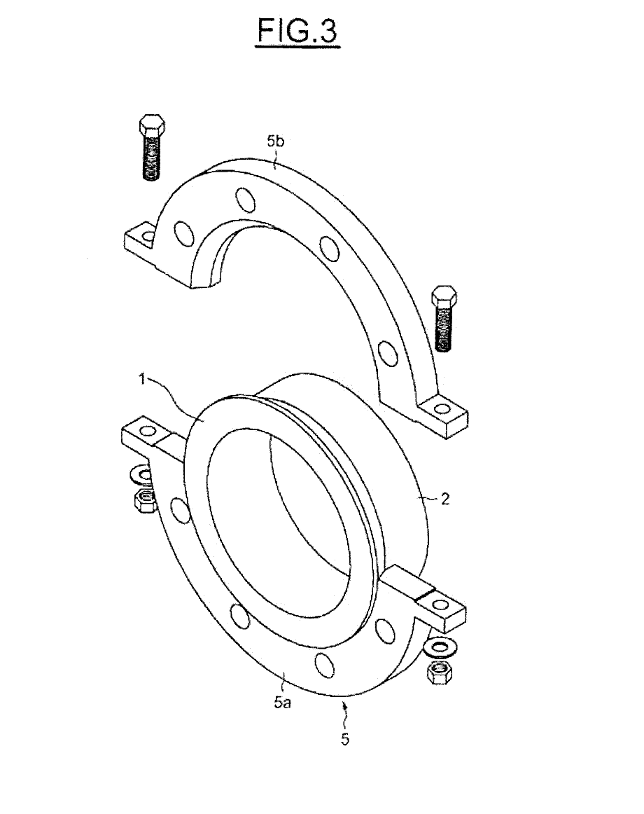

With reference to FIG. 3, which shows the pipe 2 provided with its end collar 1, the flange 5 is made in two roughly semicircular parts 5a and 5b which are intended to be joined together by bolting to form a roughly annular flange the internal diameter of which is smaller than the external diameter of the collar 1.

Although advantageous insofar as it allows the flange to be made of a material that is more resistant to the bending caused by the clamping and easier to machine, this arrangement requires the fitting out of relatively bulky and heavy flange elements, making the operation of connecting the industrial machine that bit more complicated.

It is therefore proposed that the disadvantages associated with the use of conventional flanges be addressed.

The invention therefore, in a first aspect, relates to a connection flange for connecting an industrial machine, said flange being intended to bear against a collar provided on the body of the machine and to collaborate in clamping with a corresponding connection flange.

This flange comprises an annular one-piece flange body and a split locking piece which fits around a cylindrical part of the body of the machine, the locking piece comprising a first face intended to bear against a bearing surface provided on the collar and a second face constituting a thrust surface against which the flange body presses at the time of clamping.

In one embodiment, the first face is generally frustoconical so that it bears against a frustoconical bearing surface of the collar.

According to another feature of the locking piece, the second face is planar and extends generally at right angles to the axis of clamping of the flange body to the locking piece.

The locking piece comprises, for example, cylindrical internal and external peripheral surfaces.

According to yet another feature, the flange body comprises a radial annular shoulder via which it presses, at the time of clamping, against the locking element.

The flange body may, for example, comprise an internal peripheral surface comprising a first bore having a first diameter smaller than an external diameter of the locking element and a second bore having a diameter larger than said external diameter of the locking element, the annular shoulder extending between the first and second bores.

The flange body may further be pierced with a set of axial holes for clamping it, for example using bolts, to the corresponding flange.

In one embodiment, the flange body and the locking piece are each made of steel as a single piece.

The invention also relates, according to a second aspect, to a method for connecting an industrial machine comprising a machine body provided with a connection pipe fitted with an end collar, by means of a flange as defined hereinabove.

This method involves the steps of:
fitting the flange body around the connection pipe by inserting said pipe into said flange body;
inserting the split locking element around the pipe, near the collar; and
clamping the flange body against the locking element.

Other objects, features and advantages of the invention will become apparent from reading the following description, given solely by way of nonlimiting example and made with reference to the attached drawings in which:

FIGS. 1, 2 and 3, already mentioned, illustrate examples of flanges according to the prior art;

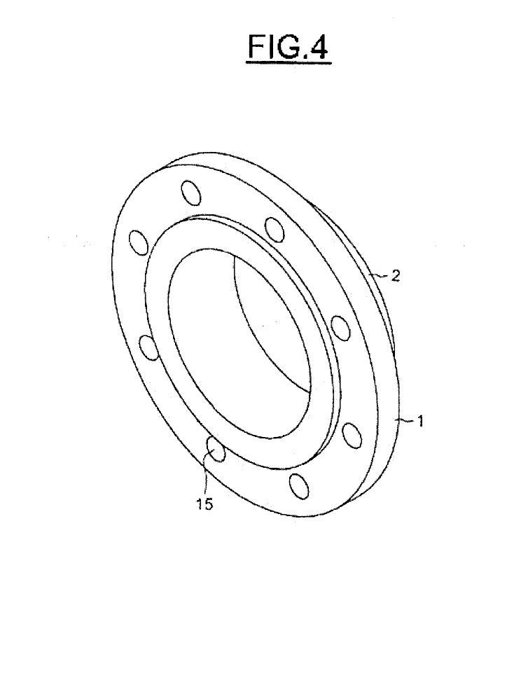

FIG. 4 is a perspective view of a connection flange according to the invention;

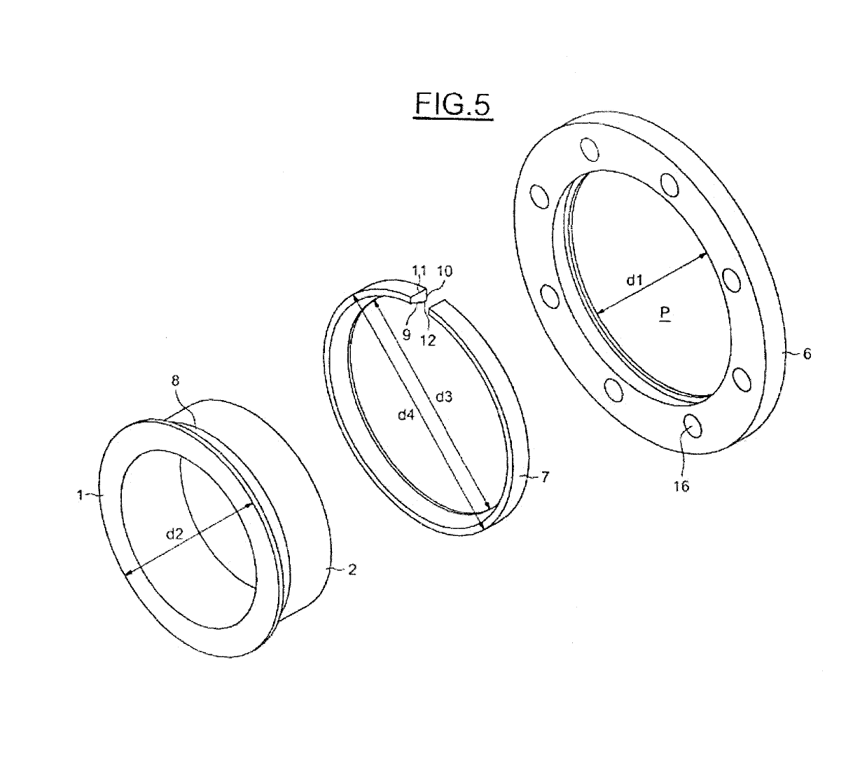

FIG. 5 is an exploded view of the flange of FIG. 4; and

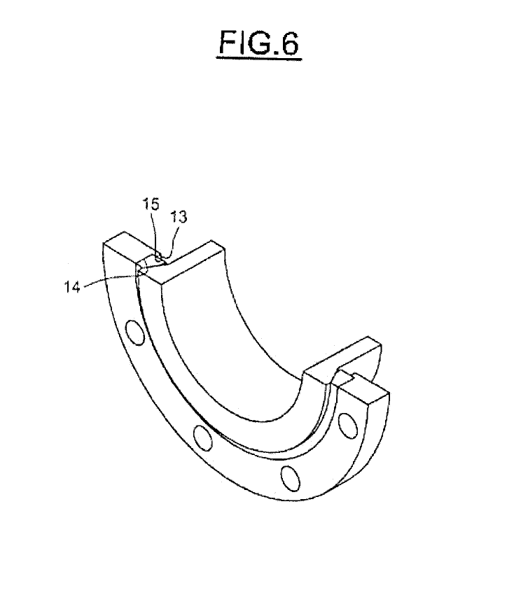

FIG. 6 is a view in cross section of the flange of FIGS. 4 and 5 on a plane stretching along the overall axis of a connection pipe of the machine.

One embodiment of a connection flange of an industrial machine will be described with reference to FIGS. 4 to 6. In the envisioned example, this flange is intended to connect a machine of the pump, valve, turbine, etc. type in a circuit of an industrial plant.

The flange is thus intended to be fitted onto the body of the machine, and in particular onto an extension of the body that forms a pipe 2, fictitiously chopped off in FIGS. 4 to 6, which is fitted with an end collar 1.

With a view to allowing the body of the machine, and the connection pipe, to withstand the abrasion caused by the nature of the materials used, the entire body of the machine, including the pipe 2, is made of a tough material, of the chromium cast iron or Ni-hard cast iron type.

The flange, for its part, is made in two parts, namely a flange body 6 and a locking piece 7.

As can be seen in FIG. 5, the flange body 6 is of annular shape and internally delimits a passage P that allows it to be inserted around the pipe. For that purpose, the smallest internal diameter d1 of the flange 6 is larger than the exterior diameter d2 of the collar 1.

The locking piece 7 is made in the form of a split ring. It is intended to press against a bearing surface 8 provided on the rear face of the collar 1. It thus constitutes a wedge against which the flange body 6 butts at the time of clamping.

Referring also to FIG. 5, it can actually be seen that the locking piece 7 comprises a front face 9 facing toward the collar 1, of a shape that complements that of the bearing surface 8 of the collar against which it is to press.

In the embodiment depicted, the front end face 9 is generally frustoconical so that it comes to bear against a bearing surface 8 that is likewise frustoconical. However, of course, it would not constitute a departure from the scope of the invention if the bearing surface 8 were produced in the form of an annular seat the plane of which extended at right angles to the axis of clamping or, in other words, to the overall axis of the pipe 2.

However, the embodiment in which the front face 9 of the locking piece 7 is frustoconical is advantageous insofar as in this case the clamping forces applied to the pipe 2 are applied essentially in compression and can therefore be easily borne by the collar 1.

As far as the rear face 10 of the locking piece 7 is concerned, that constitutes a thrust surface against which the flange body 6 rests. It has an annular overall shape extending in a plane at right angles to the axis of clamping.

The locking piece 7 further comprises an external peripheral surface 11 and an internal peripheral surface 12 both of which are cylindrical. The internal diameter d3 of the internal peripheral surface 12 is slightly larger than the external diameter of the pipe 2, while at the same time remaining smaller than the external diameter d2 of the collar 1, while the diameter d4 of the external peripheral surface is substantially larger than the diameter d2 of the collar 1, and than the diameter d1 of the passage P in order to constitute a thrust surface for the flange body 6.

The locking piece 7 is preferably made in steel as a single annular piece and is split, at the time of fitting, for example using an angle grinder, so that it can be fitted, by deforming, around the pipe 2.

As far as the flange body 6 is concerned, that comprises, internally, a first bore 13 which delimits the passage P and of which the diameter d1 is larger than the internal diameter d3 and smaller than the external diameter d4 of the locking piece 7 while remaining larger than the diameter d2 of the collar 1, and a second bore 14 of a diameter substantially larger than the external diameter d4 of the piece 7.

The two bores 13 and 14 thus delimit an annular shoulder 15 which, at the time of clamping, comes to press against the rear end face 10 of the locking piece 7 (FIG. 6).

As can be seen in FIGS. 4 to 6, the flange body 6 is also provided with a set of holes, such as 16, in this instance eight holes, but of which there may be between four and twelve, or even sixteen holes in the case of large-sized flanges, these holes 16 being intended to take a clamping screw.

The flange body 6 is for example made of steel, so that the operation of drilling the holes 16 is relatively easy to accomplish. Further, it can easily withstand the bending forces generated upon clamping. That too is the case of the locking piece 7, which is preferably made of steel.

It is relatively easy to connect an industrial machine using the flange that has just been described.

To do so, all that is required is simply for the flange body 6 to be fitted around the pipe 2, slipping it over the collar 1, then for the locking piece 7 to be inserted, by deforming it by parting it through elasticity, around the pipe 2, near the collar. The same operation is performed on the element of pipeline to be connected. The flange body 6 is then brought into abutment against the piece 7 itself pressing against the bearing surface 8. The flanges then need simply to be clamped together by bolting, with the interposition of a seal.

1-9. (canceled)

10. A connection flange for connecting an industrial machine, said flange being configured to bear against a collar provided on the body of the machine and to collaborate in clamping with a corresponding connection flange, comprising:
an annular one-piece flange body; and
a split locking piece which fits around a cylindrical part of the body of the machine, said locking piece comprising a first face configured to bear against a bearing surface provided on the collar and a second face constituting a thrust surface against which the flange body presses at the time of clamping.

11. The flange as claimed in claim 10, wherein the first face is generally frustoconical so that it bears against a frustoconical bearing surface of the collar.

12. The flange as claimed in claim 10, wherein the second face is planar and extends generally at right angles to the axis of clamping of the flange body to the locking piece.

13. The flange as claimed in claim 10, wherein the locking piece comprises cylindrical internal and external peripheral surfaces.

14. The flange as claimed in claim 10, wherein the flange body comprises a radial annular shoulder via which it presses, at the time of clamping, against the locking element.

15. The flange as claimed in claim 14, wherein the flange body comprises an internal peripheral surface comprising a first bore having a first diameter smaller than an external diameter of the locking element and a second bore having a diameter larger than said external diameter of the locking element, the annular shoulder extending between the first and second bores.

16. The flange as claimed in claim 10, wherein the flange body is pierced with a set of axial holes for clamping it to the corresponding flange.

17. The flange as claimed in claim 10, wherein the flange body and the locking piece are each made of steel as a single piece.

18. A method for connecting an industrial machine comprising a machine body provided with a connection pipe fitted with an end collar, comprising:
fitting the flange body around the connection pipe by inserting said pipe into a flange body;
fitting a split locking element around the pipe, near the collar; and
clamping the flange body against the locking element.
